(19) United States
(12) Patent Application Publication
(10) Pub. No.: US 2004/0001046 A1
(43) Pub. Date: Jan. 1, 2004

(54) Optical mouse

(76) Inventor: Shu-Fen Chen, Taichung (TW)

Correspondence Address: CHEN SHU-FEN, P.O. BOX 2103, Taichung, TW

(21) Appl. No.: 10/184,979

(22) Filed: Jul. 1, 2002

(51) Int. Cl. G09G 5/08

(52) U.S. Cl. 345/163

(57) ABSTRACT

A optical mouse having a circuit board disposed therein. A CMOS image sensing cell is arranged on the circuit board. The CMOS image sensing cell includes an image pickup unit having a viewing window. A light source is disposed under the bottom of the circuit board to project light beam downward. The light beam is projected from the light source into an image pickup range of the viewing window of the image pickup unit. Accordingly, the image pickup unit can pick up the reflected image of the light beam projected into the image pickup range. Furthermore, the CMOS image sensing cell can calculate the moving distance and direction of the optical mouse.

### BACKGROUND OF THE INVENTION

A present invention is related to an improved optical mouse in which a CMOS image sensing cell and a light source are disposed on a circuit board. A path of a light beam from the light source is shortened so as to save energy for the light source. Also, a room occupied by the light source is minified.

FIG. 4 shows a conventional optical mouse. A circuit board 71 is disposed in the housing 7 of the optical mouse. An electronic element 72 and a CMOS image sensing cell 73 are arranged on the circuit board 71 for normal operation of the optical mouse. The CMOS image sensing cell 73 has an image pickup unit 74. An LED light source 8 is disposed on the circuit board 71 beside the CMOS image sensing cell 73 to transversely project light beam. A lens combination 9 is disposed under the circuit board 71. The lens combination 9 includes an image magnifying lens 91 and a prism 92. The image magnifying lens 91 is disposed under the image pickup unit 74, while the prism 92 is positioned in front of the LED light source 8. The prism 92 has a first refractive face 921, a second refractive face 922 and a third refractive face 923.

According to principle of reflection, the incident angle is equal to reflected angle. Therefore, the light beam is first transversely projected from the LED light source 8 through the first refractive face 921 to the second refractive face 922 and then to the third refractive face 923. Then the light beam is projected from the third refractive face 923 into an image pickup range of the image pickup unit 74. Accordingly, the image pickup unit 74 can pick up the reflected image of the light beam projected into the image pickup range. Furthermore, the CMOS image sensing cell 73 can calculate the moving distance and direction of the optical mouse.

In order to fully reflect the light beam from the LED light source 8 into the image pickup range of the image pickup unit 74, according to principle of full reflection, the angle contained between the moving direction of the light beam and the normal line L of the first refractive face 921 and the normal line L of the second refractive face 922 must exceed the critical angle. Only under such circumstance, the light beam can be fully reflected from the first refractive face 921 to the second refractive face 922. When the light beam is fully reflected from the second refractive face 922 to the third refractive face 923, since the angle contained between the light beam and the normal line L of the third refractive face 923 is less than the critical angle, the light beam can be refracted from the third refractive face 923 into the image pickup range of the image pickup unit 74. However, the prism 92 is made of transparent plastic material. The critical angle of the light beam with respect to the prism 92 is about 43 degrees. Therefore, the inclination angle of the first refractive face 921 and the second refractive face 922 should not be less than 43 degrees. Accordingly, due to limitation of inclination angle of the first refractive face 921 and the second refractive face 922, the prism 92 has a considerable volume which cannot be minified.

Referring to FIG. 5, the LED light source 8 is disposed on one side of the CMOS image sensing cell 73 to transversely project light beam. Through the prism 92, the light beam is turned from transverse direction into an oblique downward direction. Therefore, through the first, second and third refractive faces 921, 922, 923, the path of the light beam is turned many times and elongated. As a result, the illumination is declined.

In order to compensate the image pickup range of the image pickup unit 74 for the loss of illumination caused by too long light path, generally a high illumination LED lamp is used as the light source. This leads to high consumption of power, especially with respect to the cell of a notebook-type computer.

In addition, the LED light source 8 transversely projects light beam and is disposed on the circuit board 71. Therefore, the volume of the circuit board 71 is enlarged to occupy more internal space of the optical mouse. Under such circumstance, the volume of the optical mouse can be hardly minified.

### SUMMARY OF THE INVENTION

It is therefore a primary object of the present invention to provide an improved optical mouse in which the light source is directly disposed under the circuit board and adjacent to the CMOS image sensing cell. Therefore, the total volume of the circuit board is minified. Furthermore, the light source downward projects light beam so that the light path is shortened and the illumination is not declined.

It is a further object of the present invention to provide the above improved optical mouse in which with the shortened light path, a relatively low illumination light source such as an SMT-type LED lamp can be used to achieve brighter illumination. Therefore, the power for the light source is saved.

The present invention can be best understood through the following description and accompanying drawings wherein:

### BRIEF DESCRIPTION OF THE DRAWINGS

FIG. 1 is a bottom view of the optical mouse of the present invention;

FIG. 2 is a bottom view of the circuit board of the optical mouse of the present invention;

FIG. 3 is a sectional view of the circuit board of the present invention, showing that the light beam projected from the light source is refracted into the image pickup range of the image pickup unit of the present invention;

FIG. 4 is a sectional view showing the interior of a conventional optical mouse; and

FIG. 5 shows the refraction of the light beam projected from the light source of the conventional optical mouse.

### DETAILED DESCRIPTION OF THE PREFERRED EMBODIMENT

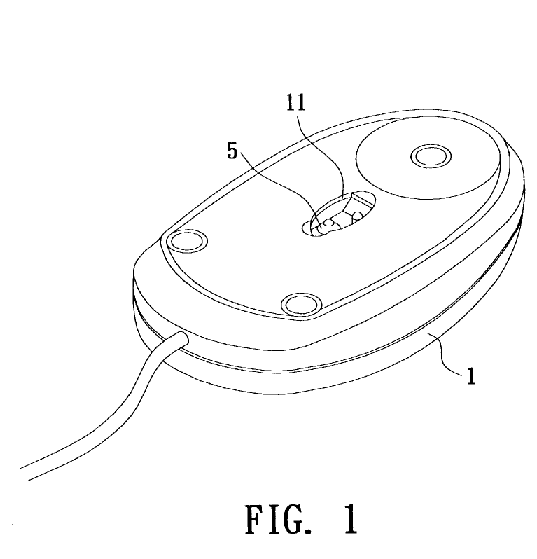

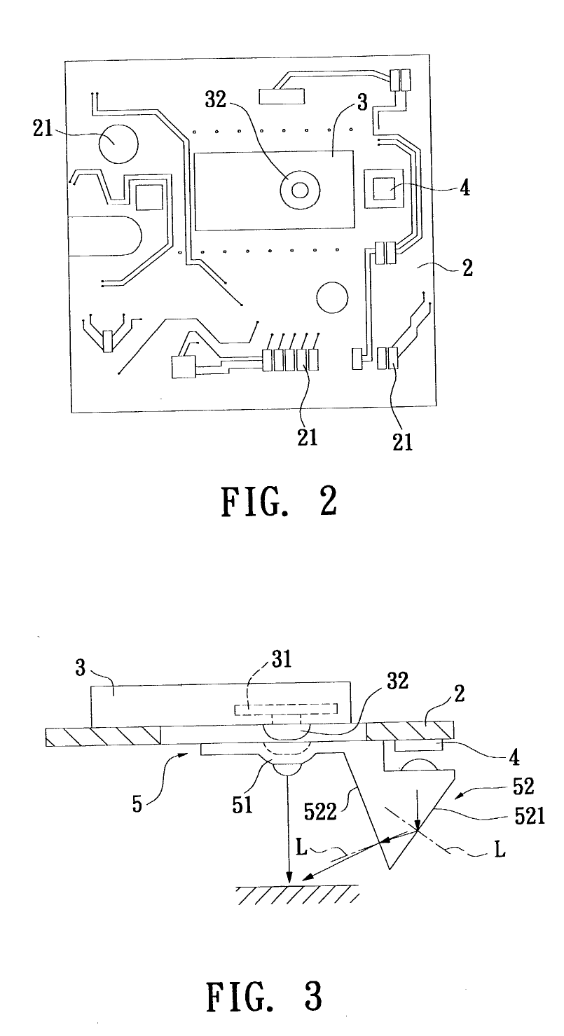

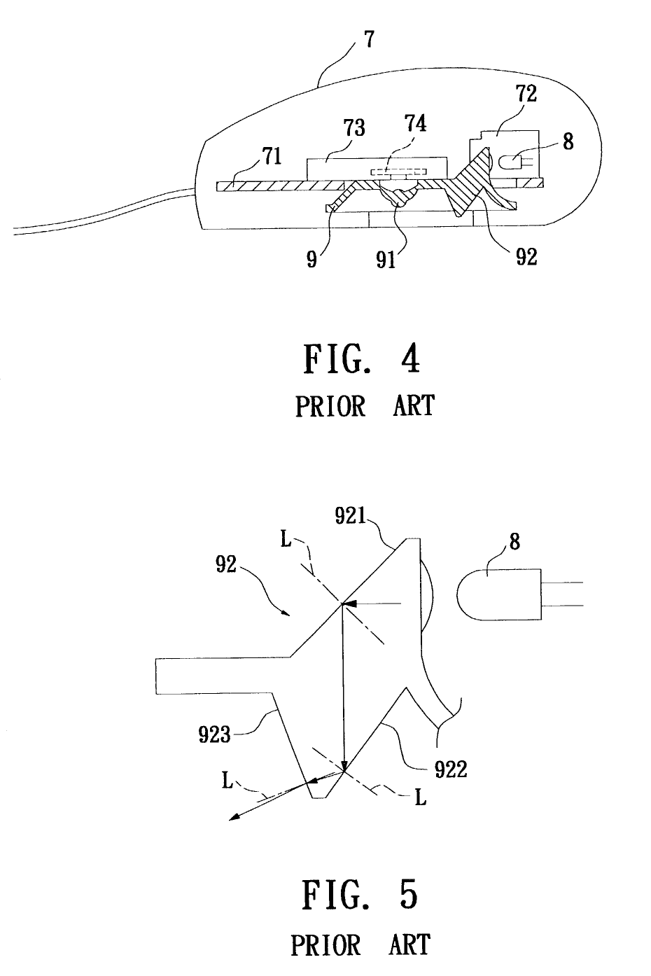

Please refer to FIGS. 1 to 3. The present invention is related to an improved optical mouse. The optical mouse has a housing 1. The bottom of the housing 1 is formed with a window 11. A circuit board 2 is disposed in the housing 1. Electronic elements 21 and a CMOS image sensing cell 3 are arranged on the circuit board 2 for normal operation of the optical mouse. The CMOS image sensing cell 3 includes an image pickup unit 31 having a viewing window 32. A SMT-type LED lamp 4 is disposed under the bottom of the circuit board 2 to project light beam downward. The SMT-type LED lamp 4 is adjacent to one side of the viewing window 32 of the image pickup unit 31. A lens combination 5 is disposed under the viewing window 32 and the SMT-type LED lamp 4. The lens combination 5 is positioned above the window 11 of the housing 1. The lens combination 5 includes an image magnifying lens 51 and a prism 52. The image magnifying lens 51 is disposed under the viewing window 32. The prism 52 has a first refractive face 521 and a second refractive face 522. The first refractive face 521 is positioned under the SMT-type LED lamp 4 and inclined by an inclination angle greater than or equal to the critical angle of the prism 52. The second refractive face 522 is inclined by an inclination angle less than the critical angle of the prism 52.

According to principle of reflection and principle of full reflection, the first refractive face 521 of the prism 52 fully reflects the downward projected light beam of the SMT-type LED lamp 4 to the second refractive face 522. Then the light beam is projected from the second refractive face 522 into an image pickup range of the viewing window 32 of the image pickup unit 31. Accordingly, the image pickup unit 31 can pick up the reflected image of the light beam projected into the image pickup range. Furthermore, the CMOS image sensing cell 3 can calculate the moving distance and direction of the optical mouse.

The SMT-type LED lamp 4 has small volume and is directly disposed under the circuit board 2 so that the total volume of the circuit board 2 is minified. Accordingly, the volume of the optical mouse is reduced.

Furthermore, the SMT-type LED lamp 4 downward projects light beam so that the prism 52 only needs to have first and a second refractive faces 521, 522. The angle contained between the normal line L of the first refractive face 521 and the light path is greater than the critical angle, while the angle contained between the normal line L of the second refractive face 522 and the light path is less than the critical angle. Therefore, only through the first and second refractive faces 521, 522, the light beam can be projected into the image pickup range of the viewing window 32. Accordingly, the volume of the prism 52 is minified and the light path is shortened. As a result, the illumination is enhanced and a sufficient illumination is provided in the image pickup range of the viewing window 32.

In addition, with the shortened light path, a relatively low illumination light source such as an SMT-type LED lamp 4 can be used to achieve sufficient illumination within the image pickup range of the viewing window 32. Therefore, the power for the SMT-type LED lamp 4 is saved.

The above embodiment is only used to illustrate the present invention, not intended to limit the scope thereof. Many modifications of the above embodiment can be made without departing from the spirit of the present invention.

What is claimed is:

1. A optical mouse having a housing in which a circuit board is disposed, a CMOS image sensing cell being arranged on the circuit board, the CMOS image sensing cell including an image pickup unit having a viewing window, a SMT-type LED lamp being disposed under the bottom of the circuit board to project light beam downward, the SMT-type LED lamp being adjacent to the image pickup unit, a lens combination being disposed under the viewing window and the SMT-type LED lamp, the lens combination including an image magnifying lens and a prism, the image magnifying lens being opposite to the viewing window, while the prism being opposite to the SMT-type LED lamp.

2. The optical mouse as claimed in claim 1, wherein the prism has a first refractive face and a second refractive face, the first refractive face being positioned under the SMT-type LED lamp and inclined by an inclination angle greater than or equal to the critical angle of the prism, the second refractive face being inclined by an inclination angle less than the critical angle of the prism.
